(19) United States
(12) Patent Application Publication
(10) Pub. No.: US 2013/0232531 A1
(43) Pub. Date: Sep. 5, 2013

(54) VIDEO AND/OR AUDIO DATA PROCESSING SYSTEM

(71) Applicant: Patrick Christian, Rowledge (GB)

(72) Inventor: Patrick Christian, Rowledge (GB)

(21) Appl. No.: 13/600,325

(22) Filed: Aug. 31, 2012

Related U.S. Application Data
(63) Continuation of application No. PCT/GB11/50403, filed on Mar. 1, 2011.

(30) Foreign Application Priority Data
Mar. 2, 2010 (GB) 1003403.1

(51) Int. Cl. H04N 21/44

(52) U.S. Cl. CPC H04N 21/44016
USPC 725/95

(57) ABSTRACT

A system and a method for the transmission of digital data which is representative of video and audio content of the type which can be used for television programming. The system allows when to end and start groups of data for the video and/or audio to be made with reference to the actual video and/or audio content and in particular to be made with reference to a detected or detectable change in the video or audio content such that the end of one group and start of the next group of data can be synchronised to occur at the same time as, or at a time determined with respect to, the change. Groups of data as self contained items or records are stored in one or more databases from which the groups can be selected and transmitted for the generation of video and/or audio content.

The invention which is the subject of this application relates to the generation of video, audio and/or auxiliary information from digital data which is transmitted from a head end by a broadcaster to a plurality of end users.

The video transmission of television services, along with the associated audio channels, has always been considered as a continuous stream in that the video images are carried as a sequence of frames which are sent at a uniform rate, without break, from the beginning to the end of the transmission. The delivery of audio is even more uniform, as, even when encoded digitally, the sound is often represented as a continuous sequence of bytes with only a start and end of the transmission. When the video is encoded digitally, which is now commonly the case, the concept of frames is used as part of the compression and encoding process. As a result of this, the majority of the frames contain data which is not the actual image of that frame itself, but rather the differences between the image of that frame and at least one of its immediate neighbouring frames.

However, in practice and in reality, the “video” or image which is being represented by data is almost never continuous. In cinema, television, home movies, the content is always broken down into different chapters, acts, scenes or views. Each individual sequence is often only a few seconds in length and even in programmes that demand a longer period without a break, such as the news or weather reports, the content is often broken up by the use of graphical inserts or overlays to maintain the interest of the viewer.

This continuous stream approach to the delivery of TV and video has been regarded as acceptable and satisfactory for many decades. Typically, with digital transmission, the frames are split into groups of pictures (GOP) in a predefined manner inasmuch that each group of pictures includes a predetermined number of frames which is constant from group to group and without regard of the actual quantity of data. This therefore means that a break in the video programme, such as for example for an advert break could occur in the middle of a GOP. Conventionally this makes it difficult to insert data into, or change the stream of, the data which is being transmitted.

It is also increasingly difficult to manage this form of data transmission as the media is increasingly offered and consumed in new and different ways. Examples of these new ways are; the provision of local or targeted advertising where standard TV commercials are replaced ‘on the fly’ and in the network, with adverts that are relevant to a narrower, or a subset of, audience; ‘trick play’ modes of video operation where it is important to fast forward or rewind video rapidly over long video sequences. Furthermore, the production of video samples, promos or clips is another way of presentation in which an extract of the video has to be created. Yet further, it can be required to black out or replace video sequences because of the legal rights of the content owner, or the performance rights of the actors.

When it is necessary to alter or replace the video quickly or ‘on the fly’, sophisticated hardware or software has to be employed to handle the process. This is a complex task, especially with the advent of digital encoding of video which normally demands a large amount of computer processing of the digital images in real time.

The aim of the present invention is to provide a new approach to the management and delivery of digitally encoded video data, which allows a more responsive and adaptable system to be utilised while, at the same time, ensuring that the delivery of the video service is maintained.

In a first aspect of the invention there is provided a system for the transmission of content in the form of video and/or audio wherein the video and/or audio is generated from digital data, said digital data encoded by encoder apparatus and transmitted to be received by receiving apparatus at at least one receiving location at which the data is decoded by decoder apparatus and the video and/or audio content generated therefrom made available for display to at least one user via display means, said video represented by a series of frames which can be generated from the transmitted data, said data for the frames is grouped together into Groups of Pictures (GOP) and wherein at the encoding stage when a predetermined change or changes is detected as having occurred or will occur in the content represented by the video and/or audio data, the encoder apparatus ends the current group of pictures and/or group of audio data and starts a new group of pictures and/or group of audio data.

Typically the change parameter or parameters which is/are detected is any or any combination of a context, scene or major image change in terms of video and/or a distinctive change in the volume, frequency or pitch in terms of audio detected in the content.

In one embodiment when a change is detected the new group of video and/or audio data commences at the same time as, or at a predetermined time with respect to, the occurrence of the detected change in the video and/or audio content.

In one embodiment, when a change in video is detected the new group of data commences with the first frame of the new scene or image. In one embodiment when a change in the audio is detected the new group of data commences with the data for the new sound following the change.

In one embodiment the invention can be performed on video only, or, for radio programming in particular, for audio only. More typically for television and other forms of display media, there will be provided a combination of video and audio data and, most typically in this use it is a detected change in the video which is used as a parameter to end one GOP and commence a new one. In this embodiment the group of data for the audio may also be stopped or ended at the same point of time as the video data GOP is caused to end or stop so that the end of a group of video data occurs at the same time as the end of the group of audio data therefore.

Typically this system allows a change of the GOP contents of the video and/or audio to be repeated upon the detection of each such change and, in this way the GOP contents and audio therefore are grouped in terms of their relationship to a particular common scene, or image in the video content, or type of audio. This means that each group can be treated as an entity and that the groups may contain a different number of frames and different levels of data for the video and audio therefore.

Typically each group, in terms of video frames and the audio therefore, can be selected and broadcast independently of the other groups although in practice the groups will most commonly be selected and broadcast in a particular sequence so as to provide the required video and/or audio content for the user.

In one embodiment a range of the groups (also referred to as records) are represented in an index and are available for selection in order to be provided to the user in a form and sequence so as to create a particular programme to be viewed and/or listened to, and the particular selection which is made is controlled with reference to a particular control setting, the form of which may be personalised to a particular viewer and/or group of viewers such that the programme, and/or adverts to be shown during the programme, can be tailored to suit a particular identified viewer or viewers by the selective showing of the groups of video and/or audio.

Typically the change between the groups of data is synchronised with the detected video display change or audio change.

In one embodiment in a television play-out system, as the raw video data is being encoded further data relating to when the video or audio change occurs or will occur is referred to as to decide where the change in the GOP or audio data should occur. Such data is, in one embodiment, run-time information from the automation system which controls the play-out of the video and/or audio and which information is collated. This provides the frame-accurate data to identify which frame is at the beginning of each new scene.

In an alternative embodiment, software is introduced into the video input to the encoder apparatus which compares each video frame with the previous one and computes a value that represents the overall difference for the detected change. If this value is above a certain threshold a scene change is concluded to have occurred. Typically one or more Algorithms can be developed to perform this function.

In a yet further embodiment and most appropriately for use with non-real time encoding of video, the transition from one scene to the next can be found using manual means by observing each frame individually.

In one embodiment, algorithms that detect a significant change in the audio may be used to identify a change which is of sufficient significance, i.e it is greater than a predetermined change parameter value to cause the group of data for the audio to stop and a new group of data for the audio to commence.

Typically, if there is no parameter change detected such as a scene change or a suitable break point after a predefined number of video frames, the encoder apparatus can be controlled to close the GOP and start a new GOP; thereby ensuring a minimum quality level is achieved by ensuring that the error rate in the decoding of the video or audio data is maintained below an acceptable threshold.

Typically most video has one or more audio tracks encoded with it. The processes and algorithms used for encoding audio are normally different from those of video and, as such, take a different amount of time and computation to complete. For this reason, the encoded video and audio output from commercial encoders is often out of phase by several seconds. This does not cause ‘lip sync’ problems as each stream is time-stamped at the encoder from a common clock such that the receiving device—for example, a set-top-box or video client software on a PC—can buffer both the audio and video and play them out in sync.

In one embodiment a group of data may contain audio data only. In one embodiment the audio in a group is that which is to be heard before a video scene change actually occurs, and a separate group is created of audio and video once the video scene change is identified and that is selected subsequently to the audio only group.

In one embodiment, upon receipt of the video and audio data, said encoded audio and video data is buffered at the encoding stage and output and transmitted to be received by the end user in a form in which both are synchronized.

This means that if any fragment of encoded video and audio is captured the sound and image will always be in sync.

In one embodiment the said groups of video and/or audio are received and organised as a sequence of records or groups, rather than a continuous stream, wherein each record or group has at least one, or any combination of, the following characteristics:

it contains a single GOP, or a number of GOP's; it contains only the audio that is associated with the specific video frames of the GOP or number of GOP's; and/or it contains supporting information which allows the video content of the record to be decoded and played in isolation.

Typically, each record or group has an identifier or set of identifiers that allows it to be indexed and referenced uniquely within a database.

In one embodiment the supporting information is a Programme Allocation Table and/or Program Map Table within an MPEG transport stream or other form of meta data.

In a further aspect of the invention there is provided a method for the transmission of content in the form of video and/or audio digital data, said method comprising the steps of encoding the data, transmitting said encoded data, representing the video data which is transmitted by frames of video, grouping the data for said frames into Groups of Pictures (GOP's) and for audio in groups of data to generate a GOP and audio group related thereto and wherein the detection of a change in the video and/or audio with reference to at least one predetermined parameter causes the ending of the current GOP and/or audio data group and commencement of a new GOP and/or group of audio data.

Typically the predetermined parameter is any of a context change, scene change, major image change for video and/or volume, pitch and/or frequency for audio.

Typically the decision to end and start respective GOP's and groups of audio data is taken at the encoding stage and the generated GOP's and groups of audio data are transmitted to a plurality of receiving locations for subsequent decoding and generation of the video to be viewed and audio to be listened to by one or more users.

Typically the end of a GOP and/or group of audio and the start of a new GOP and/or group of data is synchronised to occur at the same time or location as the detected change in the video or audio which caused the ending of the previous GOP and/or group of audio data and the commencement of the new GOP or group of audio data.

Typically the new GOP starts with the first frame of the new scene and the audio therefore such that the group is a self contained unit of data.

In a further aspect of the invention there is provided a system for the encoding of content in the form of video and/or audio wherein the video and/or audio is generated from digital data, said digital data encoded by encoder apparatus prior to onward transmission said video represented by a series of frames and data for the frames is grouped together into Groups of Pictures (GOP) and wherein when a predetermined change or changes is detected as having occurred or will occur in the content represented by the video and/or audio data, the encoder apparatus ends the current group of pictures and/or group of audio data and starts a new group of pictures and/or group of audio data.

In a further aspect of the invention there is provided a method for the transmission of content in the form of video and/or audio wherein the video and/or audio is generated from digital data, said digital data encoded by encoder apparatus and transmitted to be received by at least one receiving location at which the data is decoded and the video and/or audio content generated therefrom made available for display to at least one user, said video content represented by a series of frames which can be generated from the transmitted data, and said data for the frames is grouped together and wherein and said groups are provided as self contained groups or records which are transmitted or broadcast, or initially stored in one or more databases from which the same are available to be subsequently selected and transmitted or broadcast independently of the other groups.

In one embodiment the groups are held in databases from which the said groups can be selected for broadcast. In one embodiment a plurality of databases are provided and the groups are selectively stored in one or more of the databases with reference to predetermined criteria.

In one embodiment a plurality of said groups are selected and broadcast in a particular sequence so as to provide a specified video and/or audio content for the user.

In one embodiment a range of the groups (also referred to as records) are represented in an index and are available for selection in order to be provided to the user in a form and sequence so as to create a particular programme to be viewed and/or listened to, and the particular selection which is made is controlled with reference to a particular control setting, the form of which may be personalised to a particular viewer and/or group of viewers such that the programme, and/or adverts to be shown during the programme, can be tailored to suit a particular identified viewer or viewers by the selective showing of the groups of video and/or audio.

In one embodiment the said groups of video and/or audio are received and organised as a sequence of records or groups, rather than a continuous stream, wherein each record or group has at least one, or any combination of, the following characteristics: it contains a single GOP, or a number of GOP's; it contains only the audio that is associated with the specific video frames of the GOP or number of GOP's; and/or it contains supporting information which allows the video content of the record to be decoded and played in isolation.

Typically, each record or group has an identifier or set of identifiers that allows it to be indexed and referenced uniquely within a database.

In one embodiment the supporting information is a Programme Allocation Table and/or Program Map Table within an MPEG transport stream or other form of meta data.

Specific embodiments of the invention are now described with reference to the accompanying drawings wherein;

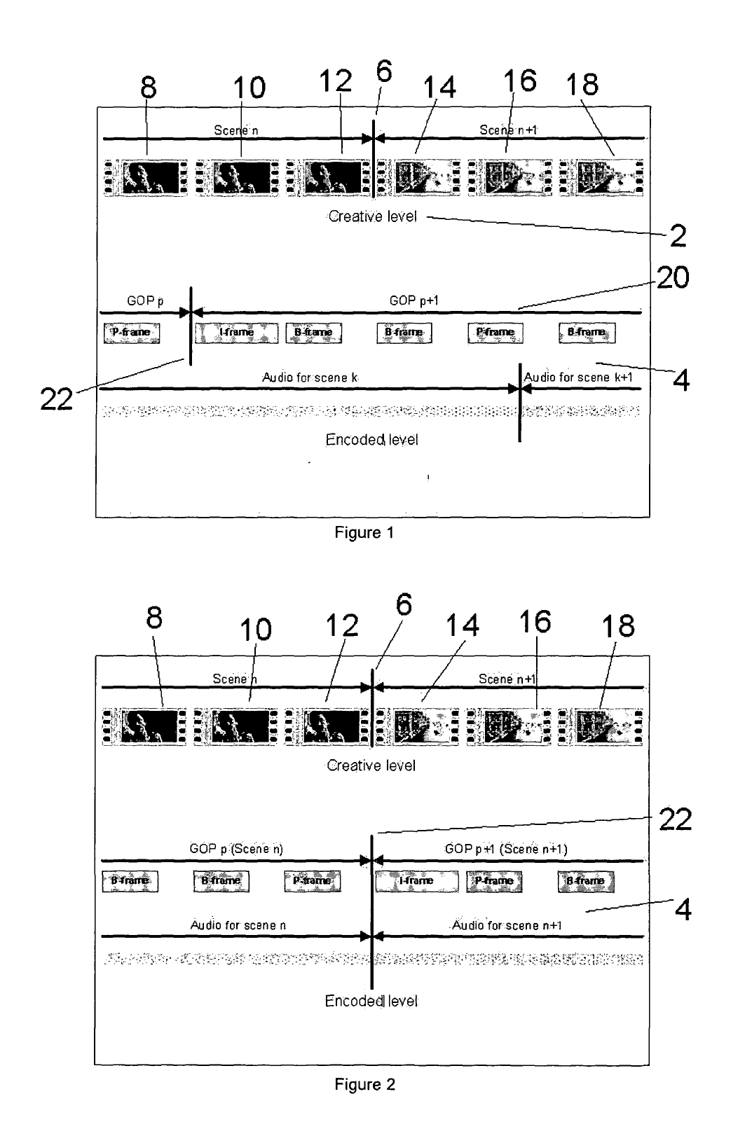

FIG. 1 illustrates a conventional processing system;

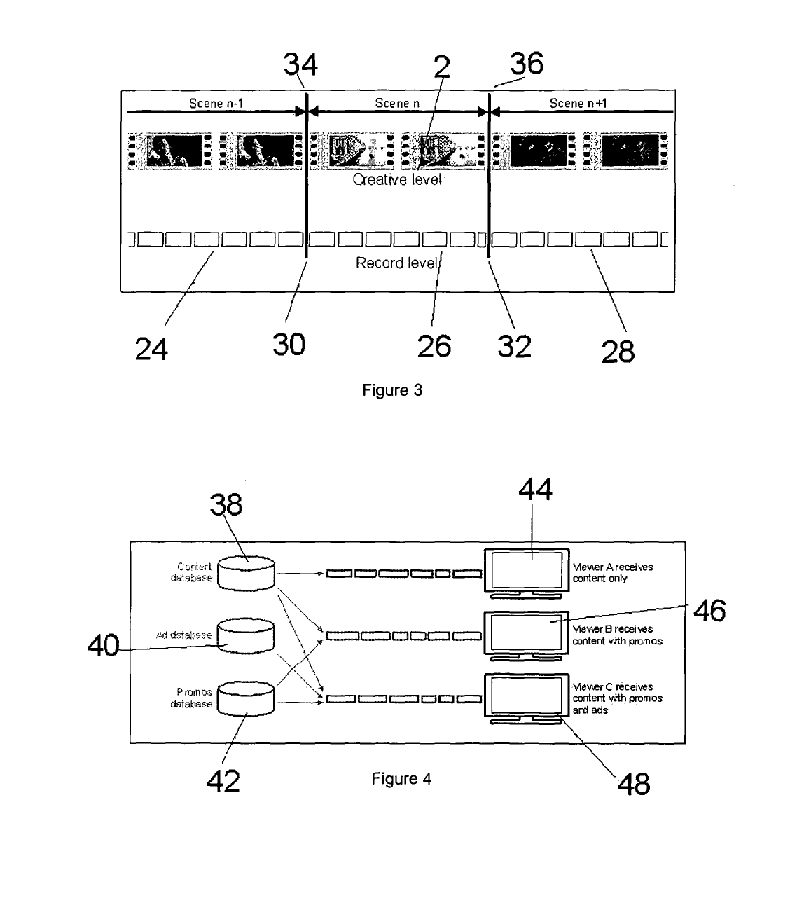

FIGS. 2, and 3 illustrate an embodiment of the invention; and

FIG. 4 illustrates a further embodiment of the invention.

The current invention relates to the transmission of content in the form of video and/or audio data. MPEG2, H.264 and other encoding and compression mechanisms for video transmission minimize the amount of bandwidth required to carry a video sequence by fully encoding a single frame (often called an I-frame, anchor frame or reference frame) and then encoding the subsequent frames (P- or B-frames) as a sequence of frames which only include data for the differences or deltas from that reference frame (the I frame) and/or other neighbouring frames. Clearly as more ‘difference’ frames are added to a sequence, errors accumulate so there is a practical limit to the number of frames that can be carried in this way before another I-frame has to be introduced. It follows therefore that, because each I-frame usually requires a much larger amount of encoding data than P- or B-frames there is always a trade-off between the bandwidth required to carry a video signal and the quality of the signal itself. The sequence of frames referring to one I-frame, is called a ‘Group of Pictures’ or GOP and provides the basis for storing, managing and distributing the video.

To simplify the encoding process, commercial video encoder apparatus generate fixed length GOPs: Usually between 10 and 20 frames for MPEG2 and up to 100 for H.264. With this approach any relationship between the video at the creative level 2 i.e the video which would be viewed by the user and that at the encoded level 4, i.e. the format in which the video data is transmitted, is lost, as is illustrated in FIG. 1. In FIG. 1 the actual video images or scenes display 2 is shown as the Creative level and the frames of the video created for the video data at the encoder apparatus are shown at the Encoded level 4. With reference to the Creative level 2, there is shown a distinctive visual break or change 6 in the video at the end of the first three images 8, 10, 12 and before the start of the next three images 14, 16,18. However at the encoded level 4, as this level is not concerned with the creative or visual appearance of the scenes but rather the treatment of the data, the start of the new group of frames (GOP) 20 occurs at the start point 22 which, as illustrated, is not synchronous with the “natural” break 6 in the video display at the creative level 2

In accordance with the invention, the use of the inventive steps defined herein allows the construction of a system where the video and/or audio content is captured, stored, indexed and distributed as a set of groups or records in a database rather than a continuous stream of data. Moreover, because the groups or records are self-contained, without the need to reference data from any other group or record, each can be played in sequence (as it was originally recorded) or in any other selected order. Also, because each group or record is in context with regard to the creative level it is possible to combine groups or records from different content to create completely new video sequences. FIGS. 2 and 3 illustrate the application of the inventive aspects in practice.

Referring to FIGS. 2 and 3, an embodiment of the invention is now set out. With regard to FIGS. 2 and 3, the immediately recognisable difference is that the break 22 between the group of pictures at the encoded level 4 is at the same location as the natural break 6 which would be desired between the video images 8,10,12 and 14,16,18 at the creative level 2. This is achieved by the detection of the change of at least one parameter which, in this case, is the significant change in the video image which occurs after the third video image 12 at the creative level 2 where the video image changes from a picture of a person to a picture of a river and buildings in image 14 so that there is a significant change in image which would be detected as a significant parameter change in the video data between the third and fourth images 12, 14. As a result of the detection of this parameter change, and in accordance with the invention, the frames for the first group of pictures(scene n) end at the same time as the change from the image of the face to the image of the river and buildings at the creative level 2 and a new group of pictures (scene n+1) are generated at the encoded level 4 at this same change. This therefore means that the break 22 between the groups of pictures, is synchronised with the significant change 6 in the video image.

A further advantage is that because the frames which are provided in each group of pictures, are linked and relate to a substantially similar feature such as, for example, the video image of the face, then each GOP can be dealt with as a separate entity. This is illustrated in FIG. 3 where a first group of pictures 24 is provided for video image scene n−1 and then a second group of pictures 26 for video image scene n and a third group of pictures 28 for video image scene n+1 with the start and end points 30, 32 of the respective groups of pictures, being synchronised to occur at the same time as the significant changes 34, 36 between the video image scenes as illustrated in FIG. 3.

FIG. 4 illustrates a further embodiment of the invention and illustrates the manner in which each of the group of pictures can be treated as a separate, independent entity and in this embodiment same can be stored as separate entities on one or more databases 38, 40, 42 which in this case comprise a database for programme content 38, a database for advert content 40 and a database for promotional material content 42. The groups can then be selectively retrieved and transmitted to one or more viewers 44, 46, 48 who as shown have different control settings. The particular groups of pictures which are retrieved and transmitted, can be determined by particular operating parameters or controls which each particular viewer or group of viewers have put in place so that each viewer or group of viewers can receive a sequence of groups of pictures which are tailored to suit a particular viewer or group of viewers requirements. For example, viewer 44 receives groups of pictures and audio from the content database 38 only, viewer 46 receives groups of pictures and audio from the contents database 38 and the database 42 and viewer 48 receives groups of pictures and audio from all three databases, 38,40,42.

In practice, and accelerated by initiatives from Apple and Akamai, the delivery of TV over the internet is becoming more ‘pull oriented’ and based on HTTP (Hypertext Transfer Protocol); paralleling the mechanisms used for delivering web pages. In this situation, the web client (browser) downloads an index file which contains links to the different components—images, text, other index files, etc—and constructs the complete web page which is presented to the user. Web-based pull TV works in a similar way. The client downloads a play-list file which contains links to the content to be played. Usually the content is ‘long form’, i.e. several seconds, minutes or even hours in length. With record-based video delivery the content can be far more granular and organized in different ways as appropriate to the viewer.

Most commercial television is funded, all or in part, by advertising. Periodically, during the transmission of the linear TV content, commercial breaks are inserted and adverts are played out. In the US, the TV broadcasters insert special markers (cue tones) into the video to allow individual cable companies to insert local advertising into some of these breaks. The equipment to do this is very sophisticated and often expensive. A ‘splicer’ has to monitor the TV signal looking for the cue tones and, as soon as it has detected them, trigger a video server to play the local ads. The splicer then replaces the original content with the ad content from the video server. At the end of the sequence it reverts back to the original TV signal. This process is complex and time critical. Both the video and the audio have to be timed with great accuracy and the inserted advert has to perfectly match the break in which it is placed. Any errors or mismatches will be immediately noticeable to the viewer.

With record-based video in accordance with the invention the problem is greatly simplified. The content would finish cleanly at the end of a record and the advert break would begin with a new record. The advert insertion system needs only to replace the original advert records with the local advert records. Timing is far less critical too. While currently each local advert break is a fixed length (usually 60 seconds) and the adverts must fit exactly, with this method an operator may choose to vary the size of each advert break according to what adverts are available as long as the total is the same over a reasonable period. For example, instead of three advert breaks of 60 seconds each, the operator may choose to have three advert breaks of 80, 60 and 40 seconds.

Some people will prefer to pay extra for their TV content so as not to have it interrupted by advert breaks while others will happily watch the adverts in order to receive their TV at a lower cost as illustrated in FIG. 4. This method makes it easy for the TV operator to include or exclude advert content on a viewer-by-viewer basis without the need for sophisticated equipment. Moreover new video services such as promotions, local weather warnings or ‘video mail’ can be inserted easily into the TV signal; again on a viewer-by-viewer basis.

The invention therefore provides a system and a method for the transmission of digital data which is representative of video and audio content of the type which can be used for television programming. The invention allows the decision of when to end and start groups of data for the video and/or audio to be made with reference to the actual video and/or audio content and in particular to be made with reference to a detected or detectable change in the video or audio content such that the end of one group and start of the next group of data can be synchronised to occur at the same time as, or at a determined time with respect to, said change. The invention also discloses the storing of the groups of data as self contained items or records and the storage of the same in one or more databases from which the groups can be selected and transmitted for the generation of video and/or audio content.

1. A system for the transmission of content in the form of video and/or audio wherein the video and/or audio is generated from digital data, said digital data encoded by encoder apparatus and transmitted to be received by receiving apparatus at at least one receiving location at which the data is decoded by decoder apparatus and the video and/or audio content generated therefrom made available for display to at least one user via display means, said video represented by a series of frames which can be generated from the transmitted data, said data for the frames is grouped together into Groups of Pictures (GOP) at or following the encoding stage, when a predetermined change or changes is detected as having occurred or will occur in the content represented by the video and/or audio data, encoder apparatus ends the current group of pictures and/or group of audio data and starts a new group of pictures and/or group of audio data, each group of pictures and/or audio is a separate entity and characterised in that each of said groups can be selected and broadcast to the at least one user independently of the other groups.

2. A system according to claim 1 wherein the parameter or parameters which is/are detected is any or any combination of a change of context, scene, or major image, in the video and/or a change in volume, frequency and/or pitch in the audio, which are detected in the content and which change is greater than a predefined level.

3. A system according to claim 1 wherein when a change is detected the new group of video and/or audio data commences at the same time as, or at a predetermined time with respect to, the occurrence of the detected change in the video and/or audio content.

4. A system according to claim 3 wherein the change of the group of pictures and/or audio is repeated upon the detection of each said parameter change such that the GOP contents and audio therefore are grouped in terms of their relationship to a particular common scene, or image in the video content, or type of audio.

5. A system according to claim 1 wherein the group of pictures and/or audio contain a different number of frames and different levels of data for the video and audio.

6. A system according to claim 1 wherein the groups are selected and transmitted and/or broadcast in a selected sequence so as to provide the required video and/or audio content for a user.

7. A system according to claim 1 wherein the groups of pictures and/or audio are represented in an index and are available for selection in order to create a particular programme to be viewed and/or listened to and the particular selection which is made is controlled with reference to at least one selection control.

8. A system according to claim 7 wherein the at least one selection control is personalised to a particular viewer and or group of viewers such that a programme, and/or adverts to be shown are tailored to suit the particular identified viewer or viewers by the selection of the groups of pictures and the audio therefore from said index.

9. A system according to claim 1 wherein the change between adjacent groups of pictures and/or audio is synchronised with the detected parameter change.

10. A system according to claim 1 wherein as the video data is being encoded, run-time information from the system which controls the play-out of the video and/or audio is collated to provide frame-accurate data to identify which frame is at the beginning of each new video scene.

11. A system according to claim 1 wherein comparison means are provided to compare each video frame with the previous one and to compute a value that represents the overall difference for the video change and if the said value is above a certain threshold a detectable parameter change in the form of a scene change is deemed to have occurred.

12. A system according to claim 1 wherein data relating to the video is provided and which data identifies where the scene change in the video or change in the audio occurs or will occur.

13. A system according to claim 1 wherein the transition from one video scene to the next is detected by observing each video frame.

14. A system according to claim 1 wherein if there is no scene change or a suitable break point after a predefined number of video frames in a group of pictures and/or audio, the encoder apparatus closes the current GOP and starts a new GOP.

15. A system according to claim 1 wherein a group contains audio data only.

16. A system according to claim 15 wherein the audio in a group is that which is to be heard before a video scene change actually occurs, and a separate group is created of audio and video data once the video scene change is identified and which separate group is selected subsequently to the audio only group.

17. A system according to claim 1 wherein upon receipt of the video and audio data, said encoded audio and video data is held in memory at the encoding stage and output so that both are synchronized.

18. A system according to claim 1 wherein the system includes means for receiving video and audio data, said means receiving and decoding selected groups of data from a range of groups of data in order to generate audio and video for a user.

19. A system according to claim 18 wherein the said means is a broadcast data receiver.

20. A system according to claim 1 wherein said groups of video and/or audio are arranged as a sequence of records or groups wherein each record or group has at least one, or any combination of the following characteristics: it contains a single GOP or a number of GOP's; it contains only the audio that is associated with the specific video frames of the GOP or the number of GOP's; and/or it contains supporting information which allows the video content of the record to be decoded and played in isolation.

21. A system according to claim 20 wherein each record or group has an identifier or set of identifiers that allows it to be indexed and referenced uniquely within a database.

22. A system according to claim 20 wherein the supporting information is a Programme Allocation Table and/or Program Map Table within an MPEG transport stream and/or other form of meta data.

23. A system for the encoding of content in the form of video and/or audio wherein the video and/or audio is generated from digital data, said digital data encoded by encoder apparatus prior to onward transmission said video represented by a series of frames and data for the frames is grouped together into Groups of Pictures (GOP) and wherein when a predetermined change or changes is detected as having occurred or will occur in the content represented by the video and/or audio data, the encoder apparatus ends the current group of pictures and/or group of audio data and starts a new group of pictures and/or group of audio data.

24. A method for the transmission of content in the form of video and/or audio digital data, said method comprising the steps of encoding the data, transmitting said encoded data, representing the video data which is transmitted by frames of video, grouping the data for said frames into Groups of Pictures (GOP's) and for audio in groups of data to generate a GOP and audio group related thereto and wherein the detection of a change in the video and/or audio with reference to at least one predetermined parameter causes the ending of the current GOP and/or audio data group and commencement of a new GOP and/or group of audio data.

25. A method according to claim 24 wherein the predetermined parameter is any of a context change, scene change, major image change for video and/or volume, pitch and/or frequency for audio.

26. A method according to claim 24 wherein the decision to end and start respective GOP's and/or groups of audio data is taken at the encoding stage and the generated GOP's and/or groups of audio data are transmitted to a plurality of receiving locations for subsequent decoding and generation of the video to be viewed and audio to be listened to by one or more users.

27. A method according to claim 24 wherein the end of a GOP and/or group of audio and the start of a new GOP and/or group of data is synchronised to occur at the same time or location as the detected change in the video or audio which caused the ending of the previous GOP and/or group of audio data and the commencement of the new GOP or group of audio data.

28. A method according to claim 24 wherein the new GOP starts with the first frame of the new scene and the audio therefore such that the group is a self contained unit of data.

29. A method according to claim 24 wherein the predetermined parameter is defined as a change which occurs beyond a predefined level with respect to a value of change in respective adjacent frames of a video display.

30. A method for the transmission of content in the form of video and/or audio wherein the video and/or audio is generated from digital data, said digital data encoded by encoder apparatus and transmitted to be received by at least one receiving location at which the data is decoded and the video and/or audio content generated therefrom made available for display to at least one user, said video content represented by a series of frames which can be generated from the transmitted data, and said data for the frames is grouped together and wherein and said groups are provided as self contained groups or records which are transmitted or broadcast, or initially stored in one or more databases from which the same are available to be subsequently selected and transmitted or broadcast independently of the other groups, each of said groups of pictures and/or groups of audio data is a separate entity and wherein each group can be selected and broadcast independently of the other groups.

31. A method according to claim 30 wherein the groups are stored in databases from which the said groups can be selected for broadcast.

32. A method according to claim 31 wherein a plurality of databases are provided and the groups are selectively stored in one or more of the databases with reference to predetermined criteria.

33. A method according to claim 30 wherein a plurality of said groups are selected and broadcast in a particular sequence so as to provide a specified video and/or audio content for the user.

34. A method according to claim 30 wherein a range of the groups are represented in an index and are available for selection in order to be provided to the user in a form and sequence so as to create a particular programme to be viewed and/or listened to, and the particular selection which is made is controlled with reference to a particular control setting, which refers to a particular viewer and/or group of viewers.

35. A method according to claim 30 wherein each record or group has an identifier or set of identifiers that allows it to be indexed and referenced uniquely within a database.

36. A method according to claim 35 wherein the supporting information is a Programme Allocation Table and/or Program Map Table within an MPEG transport stream or other form of meta data
